(19) United States
(12) Patent Application Publication
(10) Pub. No.: US 2017/0114981 A1
(43) Pub. Date: Apr. 27, 2017

(54) Layered Display System

(71) Applicant: John Schwind, Nashua, NH (US)

(72) Inventor: John Schwind, Nashua, NH (US)

(21) Appl. No.: 14/920,481

(22) Filed: Oct. 22, 2015

(51) Int. Cl. F21V 11/00

(52) U.S. Cl. CPC F21V 11/00; F21Y 2101/02; F21W 2121/00

(57) ABSTRACT

A display system is provided. The display system has a base, and a plurality of plates stacked on top of the base. The plates are formed of a transparent or translucent material and each plate has a marking on a top or bottom surface. The base includes a backlight that is beneath the stacked plates. When activated, the backlight provides a lighting which passes through the plurality of plates, illuminating the plates and the markings thereon.

### BACKGROUND OF THE INVENTION

Field of the Invention

The present invention relates generally visual art display systems. More particularly the present invention relates to a display system that has a number of painted or otherwise marked plate layers arranged in a stacked fashion, with a backlight display behind them on the base.

Description of Related Art Decoration of living spaces, offices, and the like is an important way for those in these spaces to customize and personalize their space. Typical decorations include photographs, paintings, prints, sculptures, rugs, and the like. While these serve a purpose of decorating areas, they are typically static and unchanging. This can lead such decorations to become dated, considered ugly, or inappropriate. Prior art solutions are limited to replacement of these decorations, or at best re-decorating to reconfigure the area.

Therefore, what is needed is a display system that may provide a composite display system and that may be modified and adjusted.

### SUMMARY OF THE INVENTION

The subject matter of this application may involve, in some cases, interrelated products, alternative solutions to a particular problem, and/or a plurality of different uses of a single system or article.

In one aspect, a display system is provided. The display system comprises a base, a backlight on the base, and a plurality of plates arranged on a top face of the base. The backlight light source may be mounted on the base, and is configured to project light from a top face of the base when in an activated mode. The plurality of plates on the base are arranged in a layered fashion one on top of the other. The bottom most plate in the layered composite is positioned on the top face of the base, and secured together and to the base. These plates are formed of a transparent or translucent material, and each has a marking on an upper or lower face. When the light source is activated, the markings of all of the layers can be seen, forming a composite display of the markings of each layer.

### BRIEF DESCRIPTION OF THE DRAWINGS

FIG. 1 provides an exploded view of an embodiment of the present invention.

FIG. 2 provides a view of another embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a display system for displaying art or other decorative objects. The display system comprises a base having a backlight light source, and a plurality of plate layers each having a marking on them. The plate layers are stacked on each other and positioned over the light source on the base. These layers, when stacked and positioned over the light source of the base, may provide a unique composite display system that displays the markings on each layer in combination.

The base of the present invention may be any base capable of supporting a plurality of layers resting on it and/or connected thereto. Typically, the base may be a generally flat panel shaped device, such as a rectangular, circle, or oval shaped base. However, it should be understood that a base of any size and orientation may be used as long as it is connected to the base and positioned behind where the plurality of sheets are connected to the base. In many embodiments, the base will be relatively thin, though that is not the case for all embodiments, which may be any shape.

The backlight light source of the base may be any lighting device capable of providing a light output. Examples of light sources include, but are not limited to: LED light sources, LCD displays, fluorescent lights, incandescent bulbs, and the like.

In one embodiment, the backlight light source may span all or nearly all of the top face of the base's top surface. In other embodiments, the light source may be a plurality of separate light sources spaced across the surface of the base. In still another embodiment the light source may extend about the perimeter of the base, or a perimeter of the layered plates when placed on the base. In another embodiment, the light source may be capable of varying in brightness or color. This brightness and color change ability may be controllable by a user interface, or may be performed in one or a plurality of set patters selectable by a user. It should be understood that any light source and orientation may be used as long as it is connected to the base and positioned behind where the plurality of plates are connected to the base.

A plurality of plates, each having a marking on them are removably attachable to the base in a stacked position having one on top of another. The plates are made of a transparent or translucent material such that a light from the backlight light source of the base may pass through them. The plates may be formed of a glass, Plexiglas, plastic, or the like. In one embodiment, the plates may be glass or plastic plates that are solid and substantially rigid. In another embodiment, thin flexible layers may serve as the plates. In yet another embodiment, thin film layers may serve as the plates. In varying embodiments, as long as the selected materials are transparent or translucent planar objects, they may serve as the plates. Preferably the plates have a length and width that is equal to or less than the base top face, though this is not required.

A marking may be applied directly to each of the plurality of plates. In one embodiment, the marking may be on the top face of the plate. In another embodiment, the marking may be on a bottom face of the plate. In still another embodiment, the marking may be on both a bottom and top face of the plate. This marking may be either translucent or partially translucent. In one embodiment, the marking may be made with paint, ink, dye, or other marking substance. In another embodiment, the marking may be an etching recessed in a surface of the plate.

The plates may be secured to the base in any manner. In one embodiment, a clip may connect the base to the plurality of stacked plates. In another embodiment, tape may be applied on one or more sides of the plates and connect to the base. In yet another embodiment a hinged clasp may be connected to the base and may hingedly clasp over the stack of plates on the base. In yet still another embodiment, one or more straps may extend from, or wrap around the base to wrap over a surface of the top most plate in the stacked plurality of plates.

As formed, the composite display system having the base and the plurality of marked plates on the top face of the base is then capable of display. The display may be performed by activating the backlight light source. The composite display system may be displayed on a table, wall, the ground, or other surface. The display may be angled horizontally, vertically, or at an angle using, for example, a support such as that of a picture stand.

When preparing the display system, a plurality of plates may be marked on one or more surfaces. Once the marking is complete, the plurality of plates are then stacked in a desired order and placed on the top surface of the base, above the backlight light source. Selection, ordering, and orientation of each plate may be varied and changed. The plates may be secured in place to the base by a connector as noted above. After time, as additional plates are marked, or a change is desired, additional plates may be added. Other plates may also be removed, one or more at a time, as desired by the user. In most embodiments, the plates are stacked directly on top of one another, without having an intermediary sheet such as a transparent film between them.

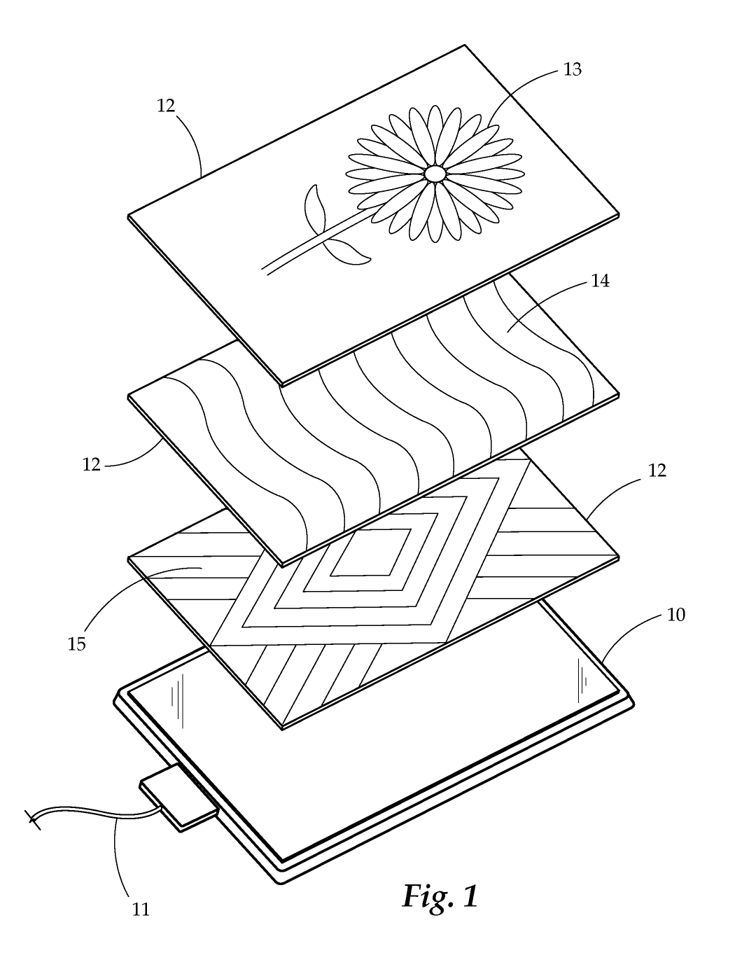

Turning now to FIG. 1, an exploded view of an embodiment of the present invention is provided. A base 10 is shown as a planar rectangular structure. As noted, the base 10 may be any shape. Power input 11 is shown as a cable, however other energy sources may be used such as a battery or the like. Power input 11 provides electrical energy to power the backlight light source 17. In the embodiment shown, light source 17 is a planar rectangular shape and is nearly as large as the top face of the base 10, and forms a portion of the top face of the base 10. Three plates 12 are shown. These plates 12 may be stacked directly on top of each other over the light source 17 and secured to the base 10. On each plate 12 is a separate marking 13, 14, 15 on a top surface of the plate 12.

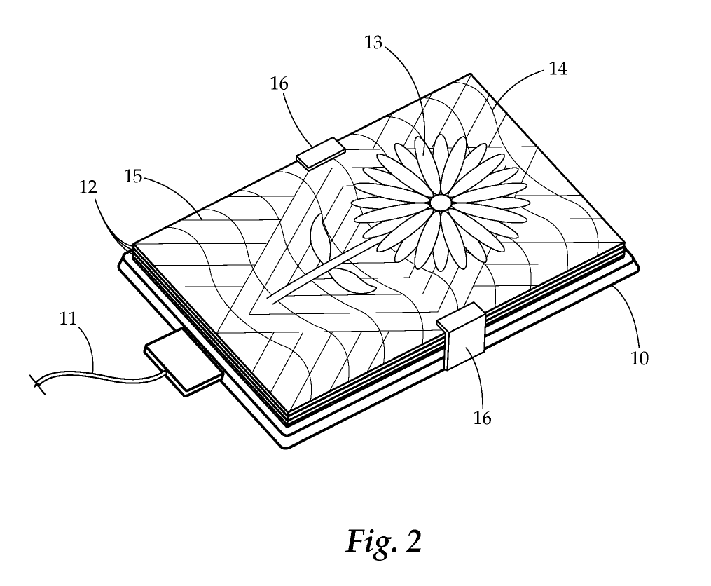

FIG. 2 shows another embodiment of the present invention. In this view, the three plates 12 are stacked directly on top of one another. Power cord 11 provides electrical power for light source (not shown) to act as a backlight. The markings of each sheet 13, 14, 15 are visible when in the stacked position, and are particularly visible when the backlight is activated. A clasp 16 is connected to base 10 and holds the sheets 12 in place.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A display system comprising:
a base;
a backlight light source mounted on the base, the backlight light source configured to project light from a top face of the base when in an active mode;
a plurality of plates arranged in a layered fashion one on top of the other, a bottom-most plate of the plurality of plates positioned on the top face, the plurality of plates attached to the top face;
wherein each of the plurality of plates is formed of one of a transparent or translucent material; and
wherein each of the plurality of plates comprises a marking on at least one of an upper or lower face.

2. The display system of claim 1 wherein each of the plurality of plates is arranged directly on top of an adjacent one of the plurality of plates, each of the plurality of plates being in direct contact with each adjacent one of the plurality of plates.

3. The display system of claim 1 wherein the base further comprises a power source providing electrical power to the backlight light source.

4. The display system of claim 1 wherein each of the plurality of plates is removable from the layered plurality of plates.

5. The display system of claim 1 wherein the base is formed as a rectangular panel.

6. The display system of claim 5 wherein the cross sectional area of the base is greater than a cross sectional area of each of the plurality of panels.

7. The display system of claim 5 wherein the cross sectional area of the base is equal to a cross sectional area of the plurality of panels.

8. The display system of claim 1 wherein the marking of each of the plurality of plates is a quantity of paint adhered to the at least one of the upper face and lower face of each of the plurality of plates.

9. The display system of claim 1 wherein the marking of each of the plurality of plates is a quantity of ink adhered to the at least one of the upper face and lower face of the each of the plurality of plates.

10. The display system of claim 1 wherein the marking of each of the plurality of plates is an etching recessed in the at least one of the upper face and lower face of each of the plurality of plates.

11. The display system of claim 1 wherein the marking of each of the plurality of plates is positioned on the upper face of each of the plurality of plates when arranged in the layered fashion.

12. The display system of claim 1 wherein the marking of each of the plurality of plates is positioned on the lower face of each of the plurality of plates when arranged in the layered fashion.

13. The display system of claim 1 further comprising a clip connected to the base, the clip being configured to attach to the plurality of layered plates to secure them in place, the clip being movable from a first securing position to a second releasing position, the releasing position allowing at least one of the plurality of plates to be removed from the layered plurality of plates, and allowing another plate to be placed on the layered plurality of plates.

14. The display system of claim 1 further comprising a strap extending from the base, the strap configured to wrap over the plurality of plates to secure them in place to the base.

15. The display system of claim 1 wherein each of the plurality of plates are each a transparent plastic sheet.

16. The display system of claim 1 wherein the backlight light source is a plurality of light emitting diodes.

17. The display system of claim 1 wherein the backlight light source has a perimeter equal to or less than a bottom most one of the plurality of plates.

18. A display comprising the display system of claim 1 mounted to a wall.

19. A display comprising the display system of claim 1 wherein the base is resting on a table.

20. A display comprising the display system of claim 1 wherein the base is on a flat surface and supported at an angle by a support.
